(19) United States
(12) Patent Application Publication
(10) Pub. No.: US 2007/0138676 A1
(43) Pub. Date: Jun. 21, 2007

(54) METHODS FOR PRODUCING GLASSLIKE CARBON

(75) Inventor: Maki HAMAGUCHI, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/466,688

(22) Filed: Aug. 23, 2006

(30) Foreign Application Priority Data
Dec. 15, 2005 (JP) 2005-361891

(51) Int. Cl. C01B 31/02

(52) U.S. Cl. 264/29.1

(57) ABSTRACT

A glasslike carbon is produced by pouring a thermosetting resin having a viscosity of 200 P or less and a mold shrinkage ratio of 2.0% to 8.0% into a concave portion of a mold, forming the thermosetting resin in the mold by heating, demolding the formed resin, and carbonizing the demolded resin.

### BACKGROUND OF THE INVENTION

1. Field of the Invention

The present invention relates to a method for producing a glasslike carbon having one or more convex portions on its surface.

2. Description of the Related Art

Glasslike carbons have various advantages such as high chemical stability, high thermal stability, and high surface hardness and are thereby used as materials for various applications such as separators for fuel cells, patterning molds for nanoimprinting, and substrates for microchemical chips. Glasslike carbons used in these applications typically have minute trenches, protrusions, or holes having a width of 100 μm or less, or around 50 nm in some cases, on their surfaces.

Techniques used in the production of such glasslike carbons having fine or minute surficial shapes are roughly categorized into the following two techniques.

One is a technique of forming a microstructure (minute shape) on a surface of a glasslike carbon by using ion beams such as focused ion beams or reactive ion beams. However, it takes a very long time to produce the surficial microstructure according to this technique, which results in poor productivity. In addition, the resulting surficial microstructure has a lower limit in its size.

The other is a technique of preparing a cured resin as a precursor of the glasslike carbon so as to have a minute surficial microstructure, in which a thermosetting resin is placed in a mold having a shape corresponding to the target surficial microstructure and then the resin in the mold is cured in situ. This technique can be found, for example, in Japanese Unexamined Patent Application Publication (JP-A) No. 2005-167077. FIGS. 3A, 3B, and 3C are schematic views illustrating the conventional method of forming and curing a resin disclosed in JP-A No. 2005-167077. FIGS. 3A and 3B are cross-sectional views of the mold and the resin charged in the mold, respectively. According to the technique disclosed in JP-A No. 2005-167077, the thermosetting resin is poured into the clearance between a female mold 3a and a male mold 3b and is cured in situ. This technique could seem to be carried out easily. However, it requires much efforts and time, because the thermosetting resin must be forced into fine concave portions 5 of the mold by applying a very high pressure of about 10 MPa for a long time in order to defoam the concave portions and to maintain a satisfactory yield. In addition, it is difficult to demold the resulting cured resin from the mold without deformation and breakage, because the thermosetting resin has been forced into the mold by applying a high pressure over a long time. The deformation and breakage also occur in regular forming procedures of thermosetting resins, such as injection molding.

### SUMMARY OF THE INVENTION

Accordingly, an object of the present invention is to provide a method for producing a glasslike carbon which enables a thermosetting resin to be charged into a concave portion of a mold even without applying a high pressure for a long time and prevents the deformation and breakage of the resin when removed from the mold.

The present invention provides a method for producing a glasslike carbon having at least one convex portion on its surface, including the steps of pouring a thermosetting resin having a viscosity of 200 P or less and a mold shrinkage ratio of 2.0% to 8.0% into at least one concave portion of a mold, forming the thermosetting resin in the mold by heating, demolding the formed resin, and carbonizing the demolded resin. When the glasslike carbon herein has only one concave portion on its surface, the other portions on the surface constitute surficial convex portions of the glasslike carbon.

The thermosetting resin for use in the step of pouring preferably has a mold shrinkage ratio of 3.0% to 7.0% so as to produce a glasslike carbon having a minimum width dimension of the surficial convex portion of 100 nm or more and less than 1 μm. The thermosetting resin more preferably has a mold shrinkage ratio of 3.0% to 5.5% so as to produce a glasslike carbon having a minimum width dimension of the surficial convex portion of 50 nm or more and less than 1 μm.

The mold for use in the method is preferably made from silicon.

The terms “viscosity” of the curable resin (thermosetting resin) and “minimum width dimension” of the convex portion herein are defined as follows. The “viscosity” is the value determined by using a Brookfield viscometer, such as a Brookfield rotational viscometer available from Eko Instruments Co., Ltd., with a rotor #4 at 30 revolutions per minute at a temperature the same as in pouring of the resin into the mold. The “minimum width dimension” means the smallest width. When the convex portion is substantially columnar, the “minimum width dimension” means the smallest diameter of the column.

The “mold shrinkage ratio” of the curable resin is determined in the following manner. A liquid thermosetting resin is placed to a depth of about 5 mm in a stainless steel mold having a rectangular trench 10 mm wide, 10 mm deep, and 100 mm long, is cured by heating at 80° C. for 72 hours, is cooled to room temperature, and is removed from the mold. The resin is then raised in temperature to 130° C. at a rate of 1° C. per minute in the air, is held to 130° C. for 60 minutes, and is cooled to room temperature. The length of the resulting formed article is measured, and the percentage of change (%) of the length of the formed article to the length of the mold (100 mm) is defined as the mold shrinkage ratio.

The method according to the present invention enables pouring of a curable resin into a concave portion of a mold while preventing foaming even without applying a high pressure over a long time and inhibits the deformation and breakage of the resin when it is removed from the mold, by selecting a thermosetting resin having a specific viscosity and a specific mold shrinkage ratio as the curable resin to be poured into the concave portion.

Further objects, features and advantages of the present invention will become apparent from the following description of the preferred embodiments with reference to the attached drawings.

### BRIEF DESCRIPTION OF THE DRAWINGS

FIGS. 1A, 1B, 1C, and 1D are cross-sectional views illustrating a method as an embodiment of the present invention;

FIG. 2 is a scanning electron micrograph of a glasslike carbon according to Example 3; and

FIGS. 3A, 3B, and 3C are cross-sectional views illustrating a conventional method for forming and curing a resin to yield a glasslike carbon having a convex portion.

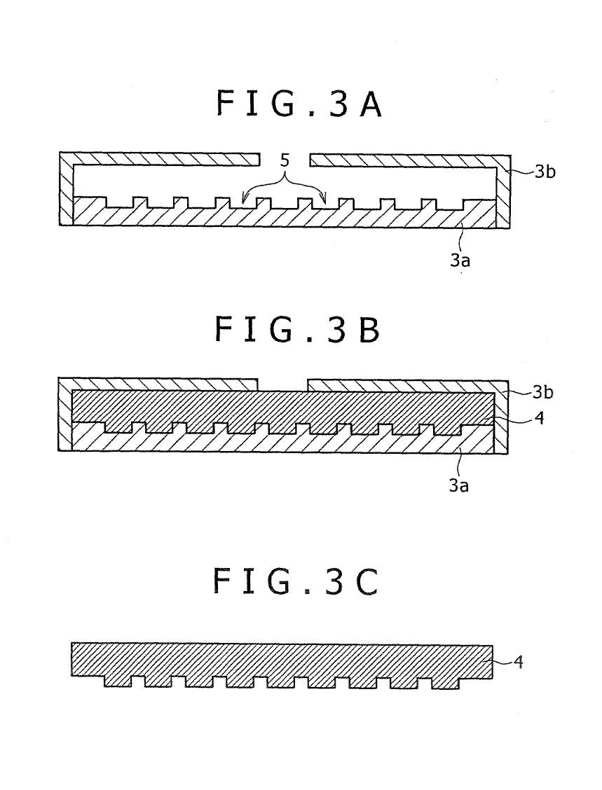

### DESCRIPTION OF THE PREFERRED EMBODIMENTS

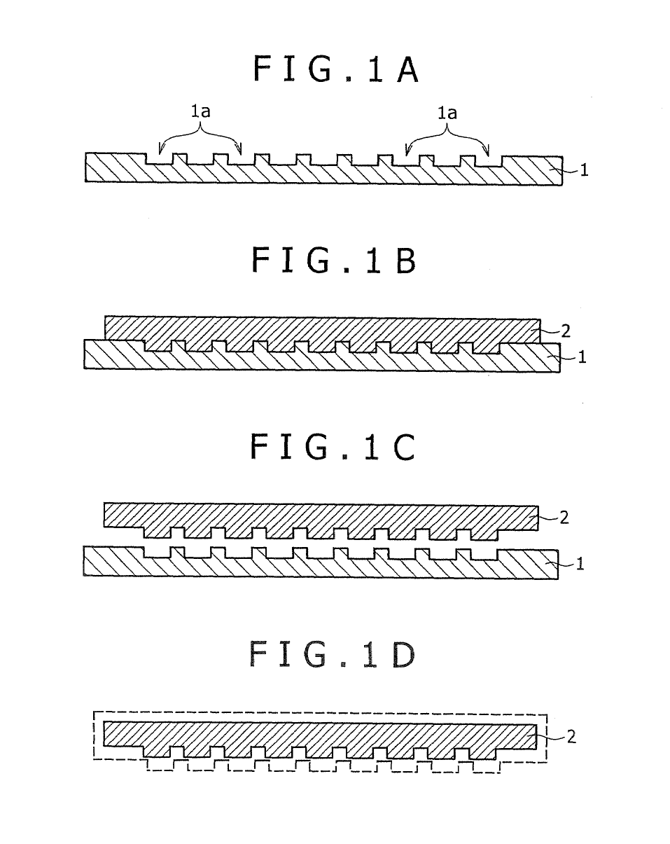

The present invention will be illustrated with reference to a preferred embodiment. The method for producing a glasslike carbon according to this embodiment sequentially carries out the steps of pouring a curable resin (thermosetting resin) into a concave portion of a mold (pouring step); forming the thermosetting resin in the mold by heating (forming step); demolding the formed resin from the mold (demolding step); and carbonizing the demolded resin (carbonizing step). FIGS. 1A, 1B, 1C, and 1D are cross-sectional views illustrating the steps according to this embodiment. Specifically, FIGS. 1A, 1B, 1C, and 1D illustrate the mold, the pouring and forming steps, the demolding step, and the carbonizing step, respectively.

Initially, the pouring step will be explained. The mold for use in the present invention is not specifically limited, as long as it has a surficial shape corresponding to the surficial shape of the target glasslike carbon. With reference to FIG. 1A, the mold 1 for use in this embodiment has trenches 1a having a minimum width of less than 1 μm and a depth of 10 μm or less on molding surface (the upper side in FIG. 1A). The mold 1 in FIG. 1A has a center line average roughness of the molding surface of 1 nm or less. The mold having such a small center line average roughness of its molding surface is suitable for producing a glasslike carbon having a highly smooth surface. The center line average roughness herein is the roughness as determined by an optical profiler WYKO (available from Veeco Instruments).

The material for the mold 1 can be a general material for molds (dies), such as stainless steel and other metals, but is silicon in this embodiment. The silicon is excellent in wettability with the curable resin and in surface smoothness. Such a silicon mold can be easily patterned according to a conventional photolithographic procedure so as to yield a molding pattern having excellent surface smoothness on its molding surface.

The curable resin can be a thermosetting resin such as a phenolic resin, a furan resin, an amino resin, an epoxy resin, an alkyd resin, a xylene resin; or a mixture of these resins. The curable resin herein must be liquid upon pouring into the mold and is thereby selected from resins which are liquid at ordinary temperature (room temperature), resins which become liquid upon heating, and resins in the form of solutions. The resin preferably has a non-volatile content of 75 percent by mass or more after heating in an oven at 130° C. A resin having a non-volatile content less than 75 percent by mass may excessively shrink in the forming step and may be susceptible to breakage.

The resin to be poured into the mold 1 is so selected as to have the above-specified viscosity at the temperature in the pouring step or is so adjusted as to have the above-specified viscosity at the temperature in the pouring step. This configuration has been found by the present inventors after intensive investigations to find a way to easily pour a resin into a concave portion of a mold. It has been believed that a resin, even if having an adjusted viscosity, cannot be poured into a concave portion of a mold, which concave portion has a minimum width dimension of 100 μm, not to speak of a concave portion having a minimum width dimension of 50 nm to 1 μm. This is because it has been believed that the resin is poured into the concave portion of the mold by the driving force of a pressure externally applied. However, the present inventors have found to utilize “wetting phenomenon” between the resin and the surface of the mold as the driving force. The “wetting phenomenon” fully differs from the conventional candidate of the driving force, i.e., external pressurization. The present inventors have further found that the resin must have a viscosity of 200 P or less at the same temperature as in the pouring step when the resin is poured into the mold by using the “wetting phenomenon” as the driving force. If the viscosity exceeds 200 P, it takes an industrially unsuitably long time to pour the resin into the mold. If the pouring of the resin having such a high viscosity is carried out in a short time, the resin cannot be poured into the mold sufficiently. The viscosity of the resin is preferably 5 P or more, more preferably 10 to 150 P, and especially preferably 30 to 130 P.

The viscosity of the resin is adjusted from the following viewpoints. The viscosity of resin increases with decreasing temperature. In contrast, the viscosity of resin decreases with elevating temperature within such temperatures at which the resin is not cured. The curing reaction of the thermosetting resin proceeds upon heating, and the resin can have a higher viscosity by heating the resin for an appropriately set heating time and allowing the curing reaction of the resin to proceed to an appropriate degree.

Of resins having the above-specified viscosity, those having the above-specified mold shrinkage ratio are selected in the present invention. The forming of the resin in the forming step is carried out by allowing the curing reaction of the resin to proceed. A resin having an excessively low mold shrinkage ratio is difficult to be removed from the mold without damage in the subsequent demolding step. In contrast, a resin having an excessively high mold shrinkage ratio is susceptible to cracking or fracture during forming. Specifically, a highly-shrinkable resin can be easily removed from the mold because of a large clearance between the mold and the resin formed as a result of shrinkage, but the resin breaks during forming. The fracture and cracking of the resin due to mold shrinkage also depends on the minimum width dimension of the convex portion on the surface of the resulting formed resin. In short, the fracture and cracking of the resin vary depending on the balance between the clearance and the shrinkage ratio. The clearance between the mold and the formed resin is necessary for removing the formed resin from the mold. The shrinkage ratio is determined so as not cause fracture of the resin during forming. The balance between the two parameters varies depending on the dimensions of the concave portion of the mold for forming the convex portion of the resin surface. By controlling the mold shrinkage ratio at 2.0% to 8.0%, the fracture and cracking of the resin can be prevented even when the resin 2 has a minimum width dimension of about 200 nm or more and less than about 1 μm. By further controlling the mold shrinkage ratio at 3.0% to 7.0%, the fracture and cracking of the resin can be prevented even when the resin 2 has a minimum width dimension of about 100 nm or more and less than about 1 μm. By further controlling the mold shrinkage ratio at 3.0% to 5.5%, the fracture and cracking of the resin can be prevented even when the resin 2 has a minimum width dimension of about 50 nm or more and less than about 1 μm.

The pouring step is carried out by pouring the resin 2 having the above-specified viscosity and mold shrinkage ratio into the molding surface of the mold 1. The resin 2 to be poured into the mold 1 has sufficient wettability with the mold 1 and is thereby sufficiently charged in the trenches 1a of the mold 1. In this embodiment, the resin 2 is in contact with the mold 1 only on the molding surface, but it may be in contact with the mold 1 in the other portions in addition to the molding surface.

The pouring step is carried out in an atmosphere under no load (atmospheric pressure) or under reduced pressure. When the resin is charged into the mold 1 under reduced pressure, the charged resin 2 can be defoamed and is prevented from containing foams.

Next, the charged resin 2 in the mold 1 is cured by heating in situ in the forming step. The heating herein is generally conducted at temperatures of about 50° C. to 150° C. for 5 to 200 hours.

Next, the demolding step will be described. In the demolding step, the resin 2 is preferably stripped off from the mold 1 (FIG. 1C). The formed resin 2 is removed from the mold by the action of mechanical stress in this embodiment, but it is also acceptable that the mold 1 alone is dissolved using a reagent such as hydrofluoric acid.

Next, the carbonizing step will be described with reference to FIG. 1D. The carbonization of the resin 2 may be carried out at temperatures of 1000° C. or higher in an atmosphere of inert gas, as in carbonization of regular cured resins. The carbonization temperature can be set higher or lower than this range. The method can further comprise a curing step between the demolding step and the carbonizing step. The curing step is carried out, for example, at temperatures of 200° C. to 250° C. in an atmosphere of the air or an inert gas for 20 to 100 hours.

The glasslike carbon is produced through these steps. Where necessary, the glasslike carbon produced by the method according to this embodiment may be processed to have a desired shape in a portion other than the portion corresponding to the molding surface before use.

The present invention will be illustrated in further detail with reference to several examples and comparative examples below. It is to be noted that the followings are only examples which by no means limit the scope of the present invention, and various changes and modifications are possible therein without departing from the teaching and scope of the present invention.

The thermosetting resin and mold used in the examples and comparative examples are as follows.

[Thermosetting Resin]

A liquid phenolic resin (the product of Gunei Chemical Industry Co., Ltd. under the trade name of PL-4807) was combined with 0.1 percent by mass of hexamethylenetetramine. The viscosity of the resulting resin was adjusted by heating the resin at 70° C. under reduced pressure of 100 mmHg. The heating time for the viscosity control was set at 0, 1, 2, 2.5, 3, 4, 5, 6, 8, or 10 hours.

[Mold]

A silicon wafer having trenches formed by photolithography was used as the mold. The trenches each have a length of 2000 μm, a depth of 100 nm and a width of 50, 100, 200, or 600 nm.

Glasslike carbons according to Examples 1 to 6 and Comparative Examples 1 to 4 were produced in the following manner.

Initially, the thermosetting resin was poured onto the molding surface of the mold while feeding 0.2 g of the resin per 10 mm² of the surface of the mold. Next, the thermosetting resin was cured by heating at a temperature of 70° C., 75° C., or 80° C. for 48 hours. The cured resin was pulled out from the mold. The demolded resin was further subjected to curing at 200° C. in the air for 48 hours. The cured resin was then carbonized by heating the resin to 1000° C. at an elevation rate of 5° C. per hour and holding the resin to 1000° C. for 5 hours in an atmosphere of nitrogen gas. The resin had a shrinkage ratio of 20% after carbonization.

The formed surfaces of the resulting glasslike carbons were observed and evaluated under a scanning electron microscope, and the results are shown in Table 1 below. The charge of the resin upon pouring into the mold, and the breakage of the resin upon removal from the mold were evaluated. The criteria in evaluations in Table 1 are as follows.

### [Resin Charging]

A: The resin is satisfactorily charged.

B: The resin is partially unsatisfactorily charged.

C: The resin is fully unsatisfactorily charged.

### [Resin Breakage]

A: The resin is not broken.

B: The resin is partially broken.

C: The resin is fully broken.

TABLE 1

| | Heating time | | Non-volatile | Forming | Mold | Upper column: Resin charge | | | |
|---|---|---|---|---|---|---|---|---|---|
| | for viscosity | Viscosity of | content | temperature | shrinkage | Lower column: Resin breakage | | | |
| | control (hr) | resin (P) | (weight %) | of resin (° C.) | ratio (%) | width 50 nm | width 100 nm | width 200 nm | width 600 nm |
| Example 1 | 2 | 15 | 75 | 70 | 7.5 | A | A | A | A |
| | | | | | | C | C | A | A |
| Example 2 | 2.5 | 28 | 76 | 70 | 6.7 | A | A | A | A |
| | | | | | | C | A | A | A |
| Example 3 | 3 | 35 | 77 | 70 | 5.3 | A | A | A | A |
| | | | | | | A | A | A | A |
| Example 4 | 4 | 85 | 78 | 70 | 3.9 | A | A | A | A |
| | | | | | | A | A | A | A |
| Example 5 | 5 | 125 | 80 | 75 | 3.1 | A | A | A | A |
| | | | | | | A | A | A | A |
| Example 6 | 6 | 190 | 82 | 80 | 2.2 | C | B | A | A |
| | | | | | | C | B | A | A |
| Com. Ex. 1 | 0 | 5 | 69 | 70 | 8.9 | A | A | A | A |
| | | | | | | C | C | C | C |
| Com. Ex. 2 | 1 | 6 | 71 | 70 | 8.2 | A | A | A | A |
| | | | | | | C | C | C | A |
| Com. Ex. 3 | 8 | 215 | 87 | 80 | 1.8 | C | C | B | A |
| | | | | | | C | C | B | A |
| Com. Ex. 4 | 10 | 230 | 89 | 80 | 1.7 | C | C | C | C |
| | | | | | | C | C | C | C |

Non-volatile content: The non-volatile content after heating in an oven at 130° C.

Table 1 verifies that by using the resins having a viscosity of 200 P or less and a mold shrinkage ratio of 2.0% to 8.0%, the glasslike carbons formed in a mold having trenches 200 nm wide show no breakage in the convex portions. It also verifies that by using the resins having a viscosity of 200 P or less and a mold shrinkage ratio of 3.0% to 7.0%, the glasslike carbons formed in a mold having trenches 100 nm wide show no breakage in the convex portions; and that by using the resins having a viscosity of 200 P or less and a mold shrinkage ratio of 3.0% to 5.5%, the glasslike carbons formed in a mold having trenches 50 nm wide show no breakage in the convex portions.

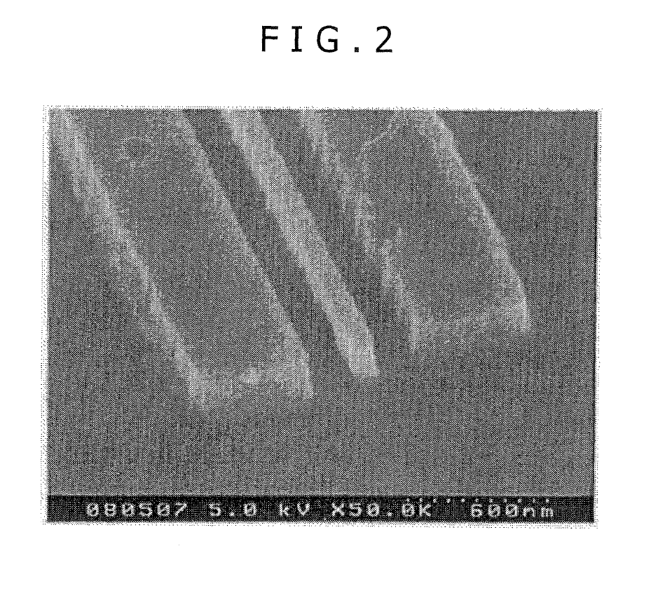

The glasslike carbons showing no breakage as evaluated in Table 1 have convex portions having a rectangular profile of a height of 80 nm and a length of 1600 μm on their surface. The center line average roughness of the convex portions was determined using the optical profiler WYKO and was found to be 0.9 nm. FIG. 2 is a scanning electron micrograph of the glasslike carbon according to Example 3, as a representative example of such glasslike carbons having convex portions without breakage.

What is claimed is:

1. A method for producing a glasslike carbon having at least one convex portion on its surface, comprising the steps of:
pouring a thermosetting resin having a viscosity of 200 P or less and a mold shrinkage ratio of 2.0% to 8.0% into at least one concave portion of a mold;
forming the thermosetting resin in the mold by heating;
demolding the formed resin; and
carbonizing the demolded resin.

2. The method according to claim 1, wherein the thermosetting resin has a mold shrinkage ratio of 3.0% to 7.0%, and wherein the glasslike carbon has a minimum width dimension of the at least one surficial convex portion of 100 nm or more and less than 1 μm.

3. The method according to claim 1, wherein the thermosetting resin has a mold shrinkage ratio of 3.0% to 5.5%, and wherein the glasslike carbon has a minimum width dimension of the at least one surficial convex portion of 50 nm or more and less than 1 μm.

4. The method according to claim 1, wherein the mold is made from silicon.

5. The method according to claim 2, wherein the mold is made from silicon.

6. The method according to claim 3, wherein the mold is made from silicon.
